(19) United States
(12) Patent Application Publication
(10) Pub. No.: US 2007/0279919 A1
(43) Pub. Date: Dec. 6, 2007

(54) Button-type tester for a lamp string

(76) Inventor: Vincent Lin, Hsin-Chu City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/492,033

(22) Filed: Jul. 25, 2006

(30) Foreign Application Priority Data
Jun. 2, 2006 (CN) 200620115723.7

(51) Int. Cl. F21V 15/00

(52) U.S. Cl. 362/362

(57) ABSTRACT

A button-type tester for a LED lamp string includes: a housing formed with a chamber to accommodate a power source component; a circuit board disposed in the chamber, and including a control circuit and a contact switch, the control circuit being connected to the power source component and being operable to activate and deactivate the lamp string, the contact switch being connected to and being operable to enable and disable operation of the control circuit; a cap mounted on the housing and permitting access into the chamber; and a cover plate movably disposed in the chamber between the cap and the contact switch and accessible via the cap for actuating the contact switch so as to control operation of the control circuit.

### CROSS-REFERENCE TO RELATED APPLICATION

This application claims priority of Chinese application no. 200620115723.7, filed on Jun. 2, 2006.

### BACKGROUND OF THE INVENTION

1. Field of the Invention

The invention relates to a tester for a lamp string, more particularly to a button-type tester for a light-emitting diode (LED) lamp string.

2. Description of the Related Art

On-site testing of electronic products by consumers is a service offered by most stores. A product testing mechanism is usually integrated with the packaging (or display box or display stand) of an electronic product to achieve the effect of enabling consumers to test operation of the electronic product before purchasing the same.

However, since the conventional product testing mechanism uses an external power source (such as a battery cell), it is difficult to integrate both the product testing mechanism and the external power source with the packaging (or display box or display stand) of the electronic product while ensuring that the external power source would not be undesirably removed.

### SUMMARY OF THE INVENTION

Therefore, the object of the present invention is to provide a button-type tester for a light-emitting diode (LED) lamp string, the button-type tester being compact in size and being suitable for integration with the packaging (or display box or display stand) of the LED lamp string to permit testing of the operation of the LED lamp string by consumers.

Accordingly, a button-type tester for a LED lamp string of the present invention comprises a housing, a power source component, a circuit board, a cap, and a cover plate.

The housing is formed with a chamber, and has an open side. The power source component is disposed in the chamber. The circuit board is disposed in the chamber, and includes a control circuit and a contact switch. The control circuit is connected electrically to the power source component, is adapted to be connected electrically to the LED lamp string, and is operable to activate and deactivate the LED lamp string. The contact switch is connected electrically to the control circuit, and is operable to enable and disable operation of the control circuit for activating and deactivating the LED lamp string. The cap is mounted on the housing at the open side and permits access into the chamber. The cover plate is movably disposed in the chamber between the cap and the contact switch, and is accessible via the cap for actuating the contact switch so as to control operation of the control circuit.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a button-type tester for a lamp string according to the present invention;

FIG. 2 is an exploded perspective view of the preferred embodiment;

FIG. 3 is a perspective view to illustrate the preferred embodiment when connected to a light-emitting diode (LED) lamp string;

FIG. 4 is a perspective view to illustrate a product package for the LED lamp string that incorporates the preferred embodiment; and

FIG. 5 is a perspective view to illustrate a display box for the LED lamp string that incorporates the preferred embodiment.

### DETAILED DESCRIPTION OF THE PREFERRED EMBODIMENT

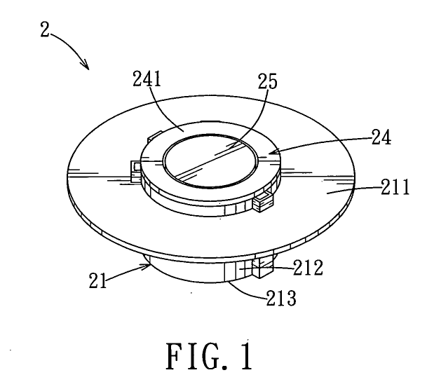

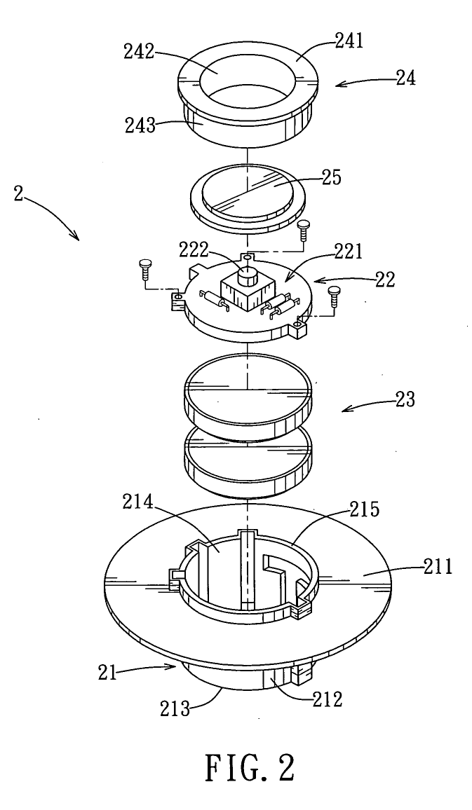

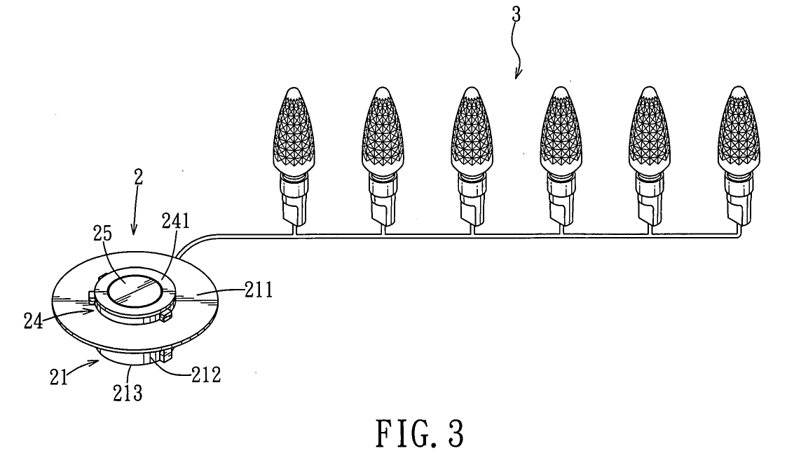

Referring to FIGS. 1, 2 and 3, the preferred embodiment of a button-type tester 2 for a light-emitting diode (LED) lamp string 3 according to the present invention is shown to comprise a housing 21, a power source component 23, a circuit board 22, a cap 24, and a cover plate 25.

The housing 21 includes an annular flange part 211, a surrounding wall part 212 extending from a bottom side of the annular flange part 211, and a bottom wall part 213 connected to a bottom periphery of the surrounding wall part 212 and cooperating with the surrounding wall part 212 to confine a chamber 214. The housing 21 has an open side 215 at the annular flange part 211.

The power source component 23 is disposed in the chamber 214, and includes a battery unit, which is a mercury battery in this embodiment.

The circuit board 22 is disposed in the chamber 214 above the power source component 23, and includes a control circuit 221 and a contact switch 222. The control circuit 221 is connected electrically to the power source component 23, is adapted to be connected electrically to the LED lamp string 3, and is operable to activate and deactivate the LED lamp string 3. The contact switch 222 is connected electrically to the control circuit 221, and is operable to enable and disable operation of the control circuit 221 for activating and deactivating the LED lamp string 3.

The cap 24 is mounted on the housing 21 at the open side 215 and permits access into the chamber 214. In this embodiment, the cap 24 includes a ring wall 241 that defines a through hole 242 to permit access to the cover plate 25, and a surrounding wall 243 that extends transversely from the ring wall 241 into the chamber 214.

The cover plate 25 is movably disposed in the chamber 214 between the cap 24 and the contact switch 222, and has a central part that is accessible via the through hole 242 in the cap 24 to permit actuation of the contact switch 222 for controlling operation of the control circuit 221.

When the button-type tester 2 is connected to the LED lamp string 3, the cover plate 25 may be pressed to actuate the contact switch 222 and enable the control circuit 221 to activate the LED lamp string 3. Thereafter, when the cover plate 25 is released, the contact switch 222 is restored to its initial state to disable the control circuit 221, thereby deactivating the LED lamp string 3.

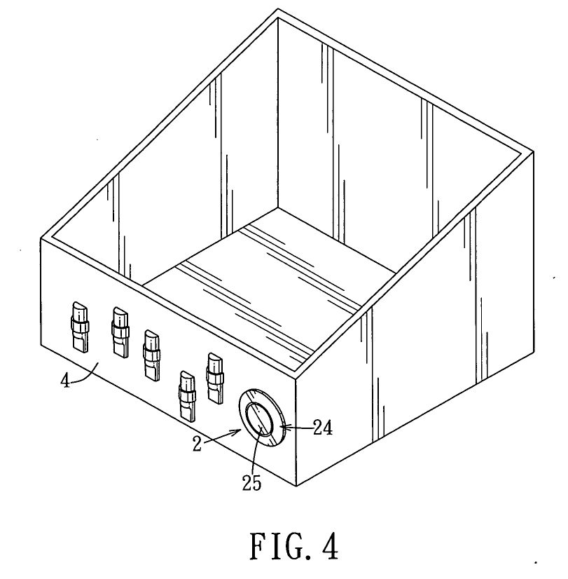

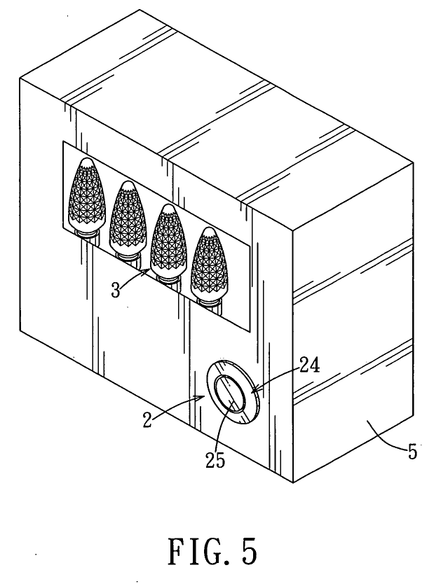

Since the button-type tester 2 that contains the power source component 23 has a relatively small and compact size, it is suitable for integration with a product package 4 (see FIG. 4) or a display box 5 (see FIG. 5) for the LED lamp string 3. Through mere operation of the cover plate 25, the contact switch 222 can be actuated so as to enable the control circuit 221 to activate the LED lamp string 3, thereby permitting consumers to test operation of the LED lamp string 3 before purchasing the same.

While the present invention has been described in connection with what is considered the most practical and preferred embodiment, it is understood that this invention is not limited to the disclosed embodiment but is intended to cover various arrangement included within the spirit and scope of the broadest interpretation so as to encompass all such modifications and equivalent arrangements.

What is claimed is:

1. A button-type tester for a light-emitting diode (LED) lamp string, said button-type tester comprising:
a housing formed with a chamber and having an open side;
a power source component disposed in said chamber;
a circuit board disposed in said chamber, and including a control circuit connected electrically to said power source component, adapted to be connected electrically to the LED lamp string and operable to activate and deactivate the LED lamp string, and a contact switch connected electrically to said control circuit and operable to enable and disable operation of said control circuit for activating and deactivating the LED lamp string;
a cap mounted on said housing at said open side and permitting access into said chamber; and
a cover plate movably disposed in said chamber between said cap and said contact switch, and accessible via said cap for actuating said contact switch so as to control operation of said control circuit.

2. The button-type tester as claimed in claim 1, wherein said cap includes a ring wall that defines a through hole to permit access to said cover plate, and a surrounding wall that extends transversely from said ring wall into said chamber.

3. The button-type tester as claimed in claim 1, wherein said power source component includes a battery unit.

4. The button-type tester as claimed in claim 3, wherein said battery unit is a mercury battery.

5. The button-type tester as claimed in claim 1, wherein said housing includes an annular flange part, a surrounding wall part extending from a bottom side of said annular flange part, and a bottom wall part connected to a bottom periphery of said surrounding wall part and cooperating with said surrounding wall part to confine said chamber.
